SEQUENCE LISTING (1 sequence)

SEQ ID NO: 1 - DNA, 10735 bp, Dengue Virus 1
  misc_feature 1..10735: Complete Genome
agttgttagtctacgtggaccgacaagaacagtttcgaatcggaagcttgcttaacgtagttctaacagttttttattagagagcagatctctgatgaacaaccaacggaaaaagacgggtcgaccgtctttcaatatgctgaaacgcgcgagaaaccgcgtgtcaactgtttcacagttggcgaagagattctcaaaaggattgctttcaggccaaggacccatgaaattggtgatggcttttatagcattcctaagatttctagccatacctccaacagcaggaattttggctagatggggctcattcaagaagaatggagcgatcaaagtgttacggggtttcaagaaagaaatctcaaacatgttgaacataatgaacaggaggaaaagatctgtgaccatgctcctcatgctgctgcccacagccctggcgttccatctgaccacccgagggggagagccgcacatgatagttagcaagcaggaaagaggaaaatcacttttgtttaagacctctgcaggtgtcaacatgtgcacccttattgcaatggatttgggagagttatgtgaggacacaatgacctacaaatgcccccggatcactgagacggaaccagatgacgttgactgttggtgcaatgccacggagacatgggtgacctatggaacatgttctcaaactggtgaacaccgacgagacaaacgttccgtcgcactggcaccacacgtagggcttggtctagaaacaagaaccgaaacgtggatgtcctctgaaggcgcttggaaacaaatacaaaaagtggagacctgggctctgagacacccaggattcacggtgatagccctttttctagcacatgccataggaacatccatcacccagaaagggatcatttttattttgctgatgctggtaactccatccatggccatgcggtgcgtgggaataggcaacagagacttcgtggaaggactgtcaggagctacgtgggtggatgtggtactggagcatggaagttgcgtcactaccatggcaaaagacaaaccaacactggacattgaactcttgaagacggaggtcacaaaccctgccgtcctgcgcaaactgtgcattgaagctaaaatatcaaacaccaccaccgattcgagatgtccaacacaaggagaagccacgctggtggaagaacaggacacgaactttgtgtgtcgacgaacgttcgtggacagaggctggggcaatggttgtgggctattcggaaaaggtagcttaataacgtgtgctaagtttaagtgtgtgacaaaactggaaggaaagatagtccaatatgaaaacttaaaatattcagtgatagtcaccgtacacactggagaccagcaccaagttggaaatgagaccacagaacatggaacaactgcaaccataacacctcaagctcccacgtcggaaatacagctgacagactacggagctctaacattggattgttcacctagaacagggctagactttaatgagatggtgttgttgacaatgaaaaaaaaatcatggctcgtccacaaacaatggtttctagacttaccactgccttggacctcgggggcttcaacatcccaagagacttggaatagacaagacttgctggtcacatttaagacagctcatgcaaaaaagcaggaagtagtcgtactaggatcacaagaaggagcaatgcacactgcgttgactggagcgacagaaatccaaacgtctggaacgacaacaatttttgcaggacacctgaaatgcagattaaaaatggataaactgattttaaaagggatgtcatatgtaatgtgcacagggtcattcaagttagagaaggaagtggctgagacccagcatggaactgttctagtgcaggttaaatacgaaggaacagatgcaccatgcaagatccccttctcgtcccaagatgagaagggagtaacccagaatgggagattgataacagccaaccccatagtcactgacaaagaaaaaccagtcaacattgaagcggagccaccttttggtgagagctacattgtggtaggagcaggtgaaaaagctttgaaactaagctggttcaagaagggaagcagtatagggaaaatgtttgaagcaactgcccgtggagcacgaaggatggccatcctgggagacactgcatgggacttcggttctataggaggggtgttcacgtctgtgggaaaactgatacaccagatttttgggactgcgtatggagttttgttcagcggtgtttcttggaccatgaagataggaatagggattctgctgacatggctaggattaaactcaaggagcacgtccctttcaatgacgtgtatcgcagttggcatggtcacactgtacctaggagtcatggttcaggcggactcgggatgtgtaatcaactggaaaggcagagaactcaaatgtggaagcggcatttttgtcaccaatgaagtccacacctggacagagcaatataaattccaggccgactcccctaagagactatcagcggccattgggaaggcatgggaggagggtgtgtgtggaattcgatcagccactcgtctcgagaacatcatgtggaagcaaatatcaaatgaattaaaccacatcttacttgaaaatgacatgaaatttacagtggtcgtaggagacgttagtggaatcttggcccaaggaaagaaaatgattaggccacaacccatggaacacaaatactcgtggaaaagctggggaaaagccaaaatcataggagcagatgtacagaataccaccttcatcatcgacggcccaaacaccccagaatgccctgataaccaaagagcatggaacatttgggaagttgaagactatggatttggaattttcacgacaaacatatggttgaaattgcgtgactcctacactcaagtgtgtgaccaccggctaatgtcagctgccatcaaggatagcaaagcagtccatgctgacatggggtactggatagaaagtgaaaagaacgagacttggaagttggcaagagcctccttcatagaagttaagacatgcatctggccaaaatcccacactctatggagcaatggagtcctggaaagtgagatgataatcccaaagatatatggaggaccaatatctcagcacaactacagaccaggatatttcacacaaacagcagggccgtggcacttgggcaagttagaactagattttgatttatgtgaaggtaccactgttgttgtggatgaacattgtggaaatcgaggaccatctcttagaaccacaacagtcacaggaaagacaatccatgaatggtgctgtagatcttgcacgttaccccccctacgtttcaaaggagaagacgggtgctggtacggcatggaaatcagaccagtcaaggagaaggaagagaacctagttaagtcaatggtctctgcagggtcaggagaagtggacagtttttcactaggactgctatgcatatcaataatgatcgaagaggtaatgagatccagatggagcagaaaaatgctgatgactggaacattggctgtgttcctccttctcacaatgggacaattgacatggaatgatctgatcaggctatgtatcatggttggagccaacgcttcagacaagatggggatgggaacaacgtacctagctttgatggccactttcagaatgagaccaatgttcgcagtcgggctactgtttcgcagattaacatctagagaagttcttcttcttacagttggattgagtctggtggcatctgtagaactaccaaattccttagaggagctaggggatggacttgcaatgggcatcatgatgttgaaattactgactgattttcagtcacatcagctatgggctaccttgctgtctttaacatttgtcaaaacaactttttcattgcactatgcatggaagacaatggctatgatactgtcaattgtatctctcttccctttatgcctgtccacgacttctcaaaaaacaacatggcttccggtgttgctgggatctcttggatgcaaaccactaaccatgtttcttataacagaaaacaaaatctggggaaggaaaagctggcctctcaatgaaggaattatggctgttggaatagttagcattcttctaagttcacttctcaagaatgatgtgccactagctggcccactaatagctggaggcatgctaatagcatgttatgtcatatctggaagctcggccgatttatcactggagaaagcggctgaggtctcctgggaagaagaagcagaacactctggtgcctcacacaacatactagtggaggtccaagatgatggaaccatgaagataaaggatgaagagagagatgacacactcaccattctcctcaaagcaactctgctagcaatctcaggggtatacccaatgtcaataccggcgaccctctttgtgtggtatttttggcagaaaaagaaacagagatcaggagtgctatgggacacacccagccctccagaagtggaaagagcagtccttgatgatggcatttatagaattctccaaagaggattgttgggcaggtctcaagtaggagtaggagtttttcaagaaggcgtgttccacacaatgtggcacgtcaccaggggagctgtcctcatgtaccaagggaagagactggaaccaagttgggccagtgtcaaaaaagacttgatctcatatggaggaggttggaggtttcaaggatcctggaacgcgggagaagaagtgcaggtgattgctgttgaaccggggaagaaccccaaaaatgtacagacagcgccgggtaccttcaagacccctgaaggcgaagttggagccatagctctagactttaaacccggcacatctggatctcctatcgtgaacagagagggaaaaatagtaggtctttatggaaatggagtggtgacaacaagtggtacctacgtcagtgccatagctcaagctaaagcatcacaagaagggcctctaccagagattgaggacgaggtgtttaggaaaagaaacttaacaataatggacctacatccaggatcgggaaaaacaagaagataccttccagccatagtccgtgaggccataaaaagaaagctgcgcacgctagtcttagctcccacaagagttgtcgcttctgaaatggcagaggcgctcaagggaatgccaataaggtatcagacaacagcagtgaagagtgaacacacgggaaaggagatagttgaccttatgtgtcacgccactttcactatgcgtctcctgtctcctgtgagagttcccaattataatatgattatcatggatgaagcacattttaccgatccagccagcatagcagccagagggtatatctcaacccgagtgggtatgggtgaagcagctgcgattttcatgacagccactccccccggatcggtggaggcctttccacagagcaatgcagttatccaagatgaggaaagagacattcctgaaagatcatggaactcaggctatgactggatcactgatttcccaggtaaaacagtctggtttgttccaagcatcaaatcaggaaatgacattgccaactgtttaagaaagaatgggaaacgggtggtccaattgagcagaaaaacttttgacactgagtaccagaaaacaaaaaataacgactgggactatgttgtcacaacagacatatccgaaatgggagcaaacttccgagccgacagggtaatagacccgaggcggtgcctgaaaccggtaatactaaaagatggcccagagcgtgtcattctagccggaccgatgccagtgactgtggctagcgccgcccagaggagaggaagaattggaaggaaccaaaataaggaaggcgatcagtatatttacatgggacagcctctaaacaatgatgaggaccacgcccattggacagaagcaaaaatgctccttgacaacataaacacaccagaagggattatcccagccctctttgagccggagagagaaaagagtgcagcaatagacggggaatacagactacggggtgaagcgaggaaaacgttcgtggagctcatgagaagaggagatctacctgtctggctatcctacaaagttgcctcagaaggcttccagtactccgacagaaggtggtgctttgatggggaaaggaacaaccaggtgttggaggagaacatggacgtggagatctggacaaaagaaggagaaagaaagaaactacgaccccgctggctggatgccagaacatactctgacccactggctctgcgcgaattcaaagagttcgcagcaggaagaagaagcgtctcaggtgacctaatattagaaatagggaaacttccacaacatttaacgcaaagggcccagaacgccttggacaatctggttatgttgcacaactctgaacaaggaggaaaagcctatagacacgccatggaagaactaccagacaccatagaaacgttaatgctcctagctttgatagctgtgctgactggtggagtgacgttgttcttcctatcaggaaggggtctaggaaaaacatccattggcctactctgcgtgattgcctcaagtgcactgttatggatggccagtgtggaaccccattggatagcggcctctatcatactggagttctttctgatggtgttgcttattccagagccggacagacagcgcactccacaagacaaccagctagcatacgtggtgataggtctgttattcatgatattgacagtggcagccaatgagatgggattactggaaaccacaaagaaggacctggggattggtcatgcagctgctgaaaaccaccatcatgctgcaatgctggacgtagacctacatccagcttcagcctggactctctatgcagtggccacaacaattatcactcccatgatgagacacacaattgaaaacacaacggcaaatatttccctgacagctattgcaaaccaggcagctatattgatgggacttgacaagggatggccaatatcaaagatggacataggagttccacttctcgccttggggtgctattctcaggtgaacccgctgacgctgacagcggcggtattgatgctagtggctcattatgccataattggacccggactgcaagcaaaagctactagagaagctcaaaaaaggacagcagccggaataatgaaaaacccaactgtcgacgggatcgttgcaatagatttggaccctgtggtttacgatgcaaaatttgaaaaacagctaggccaaataatgttgttgatactttgcacatcacagatcctcctgatgcggaccacatgggccttgtgtgaatccatcacactagccactggacctctgactacgctttgggagggatctccaggaaaattctggaacaccacgatagcggtgtccatggcaaacatttttaggggaagttatctagcaggagcaggtctggccttttcattaatgaaatctctaggaggaggtaggagaggcacgggagcccaaggggaaacactgggagaaaaatggaaaagacagctaaaccaattgagcaagtcagaattcaacacttacaaaaggagtgggattatagaggtggatagatctgaagccaaagaggggttaaaaagaggagaaacgactaaacacgcagtgtcgagaggaacggccaaactgaggtggtttgtggagaggaaccttgtgaaaccagaagggaaagtcatagacctcggttgtggaagaggtggctggtcatattattgcgctgggctgaagaaagtcacagaagtgaaaggatacacgaaaggaggacctggacatgaggaaccaatcccaatggcaacctatggatggaacctagtaaagctatactccgggaaagatgtattctttacaccacctgagaaatgtgacaccctcttgtgtgatattggtgagtcctctccgaacccaactatagaagaaggaagaacgttacgtgttctaaagatggtggaaccatggctcagaggaaaccaattttgcataaaaattctaaatccctatatgccgagtgtggtagaaactttggagcaaatgcaaagaaaacatggaggaatgctagtgcgaaatccactctcaagaaactccactcatgaaatgtactgggtttcatgtggaacaggaaacattgtgtcagcagtaaacatgacatctagaatgctgctaaatcgattcacaatggctcacaggaagccaacatatgaaagagacgtggacttaggcgctggaacaagacatgtggcagtagaaccagaggtggccaacctagatatcattggccagaggatagagaatataaaaaatgaacacaaatcaacatggcattatgatgaggacaatccatacaaaacatgggcctatcatggatcatatgaggtcaagccatcaggatcagcctcatccatggtcaatggtgtggtgagactgctaaccaaaccatgggatgtcattcccatggtcacacaaatagccatgactgacaccacaccctttggacaacagagggtgtttaaagagaaagttgacacgcgtacaccaaaagcgaaacgaggcacagcacaaattatggaggtgacagccaggtggttatggggttttctctctagaaacaaaaaacccagaatctgcacaagagaggagttcacaagaaaagtcaggtcaaacgcagctattggagcagtgttcgttgatgaaaatcaatggaactcagcaaaagaggcagtggaagatgaacggttctgggaccttgtgcacagagagagggagcttcataaacaaggaaaatgtgccacgtgtgtctacaacatgatgggaaagagagagaaaaaattaggagagttcggaaaggcaaaaggaagtcgcgcaatatggtacatgtggttgggagcgcgctttttagagtttgaagcccttggtttcatgaatgaagatcactggttcagcagagagaattcactcagtggagtggaaggagaaggactccacaaacttggatacatactcagagacatatcaaagattccagggggaaatatgtatgcagatgacacagccggatgggacacaagaataacagaggatgatcttcagaatgaggccaaaatcactgacatcatggaacctgaacatgccctattggccacgtcaatctttaagctaacctaccaaaacaaggtagtaagggtgcagagaccagcgaaaaatggaaccgtgatggatgtcatatccagacgtgaccagagaggaagtggacaggttggaacctatggcttaaacaccttcaccaacatggaggcccaactaataagacaaatggagtctgagggaatcttttcacccagcgaattggaaaccccaaatctagccgaaagagtcctcgactggttgaaaaaacatggcaccgagaggctgaaaagaatggcaatcagtggagatgactgtgtggtgaaaccaatcgatgacagatttgcaacagccttaacagctttgaatgacatgggaaaggtaagaaaagacataccgcaatgggaaccttcaaaaggatggaatgattggcaacaagtgcctttctgttcacaccatttccaccagctgattatgaaggatgggagggagatagtggtgccatgccgcaaccaagatgaacttgtaggtagggccagagtatcacaaggcgccggatggagcttgagagaaactgcatgcctaggcaagtcatatgcacaaatgtggcagctgatgtacttccacaggagagacttgagattagcggctaatgctatctgttcagccgttccagttgattgggtcccaaccagccgcaccacctggtcgatccatgcccaccatcaatggatgacaacagaagacatgttgtcagtgtggaatagggtttggatagaggaaaacccatggatggaggacaagactcatgtgtccagttgggaagacgttccatacctaggaaaaagggaagatcaatggtgtggttccctaataggcttaacagcacgagccacctgggccaccaacatacaagtggccataaaccaagtgagaaggctcattgggaatgagaattatctagacttcatgacatcaatgaagagattcaaaaacgagagtgatcccgaaggggcactctggtaagccaactcattcacaaaataaaggaaaataaaaaatcaaacaaggcaagaagtcaggccggattaagccatagcacggtaagagctatgctgcctgtgagccccgtccaaggacgtaaaatgaagtcaggccgaaagccacggttcgagcaagccgtgctgcctgtagctccatcgtggggatgtaaaaacccgggaggctgcaaaccatggaagctgtacgcatggggtagcagactagtggttagaggagacccctcccaagacacaacgcagcagcggggcccaacaccaggggaagctgtaccctggtggtaaggactagaggttagaggagaccccccgcacaacaacaaacagcatattgacgctgggagagaccagagatcctgctgtctctacagcatcattccaggcacagaacgccaaaaaatggaatggtgctgttgaatcaacaggttct

(19) United States
(12) Patent Application Publication
(10) Pub. No.: US 2013/0013220 A1
(43) Pub. Date: Jan. 10, 2013

(54) METHOD AND APPARATUS FOR ANALYZING DNA

(75) Inventor: MAI WANG, SAN JOSE, CA (US)

(73) Assignee: MAI WANG, SAN JOSE, CA (US)

(21) Appl. No.: 13/538,736

(22) Filed: Jun. 29, 2012

Related U.S. Application Data
(63) Continuation-in-part of application No. 12/391,866, filed on Feb. 24, 2009, now abandoned.
(60) Provisional application No. 61/045,511, filed on Apr. 16, 2008.
(60) Provisional application No. 61/102,989, filed on Oct. 6, 2008.

(51) Int. Cl. G06F 19/00

(52) U.S. Cl. 702/20

(57) ABSTRACT

The distribution and/or ratio of Thymine, Cytosine, Adenine and Guanine of a DNA sequence from a target organism are organized and analyzed. The result is then used to determine the possible impacts the target organism may have in a host such as a human body. The corresponding treatment and prevention strategies may also be determined. The goal is to provide an effective way to diagnose, treat and prevent diseases such as infectious diseases, to test the safety of food and drugs, and therefore to create natural and effective solutions for health care and food supply. For example, a DNA analysis method configured according to the invention receives a DNA sequence input and converts it into a reassembled sequence. A result based on the reassembled sequence may then be output. Determination of the analysis result, treatment and prevention strategies may also be output.

### RELATED APPLICATIONS

This application is a Continuation-In-Part of application Ser. No. 12/391,866, filed Feb. 24, 2009, incorporated herein by reference in its entirety, which claims priorities based on U.S. Provisional Patent Application No. 61/045,511, filed on Apr. 16, 2008, entitled “Protocol and Apparatus for Analyzing DNA” and Provisional Patent Application No. 61/102,989, filed on Oct. 6, 2008, entitled “Protocol and Apparatus for Analyzing DNA (2).”

### BACKGROUND OF THE INVENTION

Infectious Disease is a global problem. Each year, it cost 13 million lives worldwide and US government alone $120 billion dollars.

However, none of the existing medical approaches, including Conventional Western Medicine and Traditional Chinese Medicine offer effective solutions to the problem. For example, antibiotics are used for treating bacterial infections, but we found more and more bugs becoming drug-resistant these days. There is virtually no treatment solution for viral infection. Vaccines are used to prevent the diseases but they often take too long to make and they are too expensive for the developing countries to afford.

On the other hand, Traditional Chinese Medicine (TCM) offers great experiences in using herbs to treat certain types of infectious diseases. We did see amazing results in Asia during the SARS period. However, the pathogens often spread and mutate too fast. When a new disease surfaces the society, no one has any experiences about disease. All doctors have to face the same challenge.

Traditional Chinese Medicine believes that disease is caused by imbalance within the patient. But how does a pathogen cause imbalance on its host? To a doctor, this diagnosis will not be meaningful unless he or she can actually visualize or measure the imbalance and correct it. As an inventor and a practitioner, my goal is to find a method which allow us to diagnose, treat and prevent disease effectively.

This invention, which combines life science and Traditional Chinese Medicine theories, offers a novel solution to the problem in simply few steps: (1) reassemble and analyze the DNA sequence of the target organism, (2) use the analysis result to determine the impacts the target organism may have on a host such as human, (3) suggest treatment and preventive strategies.

Over 120 pathogen genomes have been analyzed using this invention and the results (i.e. predicted symptoms) matched well with the data released from CDC, WHO and other research journals. The results are consistent with high accuracy.

### BRIEF DESCRIPTION OF THE DRAWINGS

FIG. 1 illustrates a prior art concept.

FIG. 2 illustrates an embodiment of the invention.

FIG. 3 illustrates an embodiment of the invention.

FIG. 4 illustrates an embodiment of the invention.

FIG. 5 illustrates an embodiment of the invention.

FIG. 6 illustrates an embodiment of the invention.

FIG. 7 illustrates an embodiment of the invention.

FIG. 8A, FIG. 8B and FIG. 8C illustrate an embodiment of the invention.

FIG. 9 illustrates an embodiment of the invention.

FIG. 10 illustrates an embodiment of the invention.

FIG. 11 illustrates an embodiment of the invention.

FIG. 12A, FIG. 12B and FIG. 12C illustrate an embodiment of the invention

FIG. 13A and FIG. 13B illustrate an embodiment of the invention

### DETAILED DESCRIPTION OF THE INVENTION

This invention is directed to a protocol and design for an apparatus to analyze the distribution and/or ratio of Thymine, Cytosine, Adenine and Guanine of a DNA sequence from a target organism. The result is then used to determine the possible impact of a foreign DNA sequence, such as a pathogen, may have in a host such as a human body. The goal is to provide an effective way to diagnose, treat and prevent diseases such as infectious diseases, to test the safety of food and drugs, and therefore to create natural and effective solutions for health care and food supply.

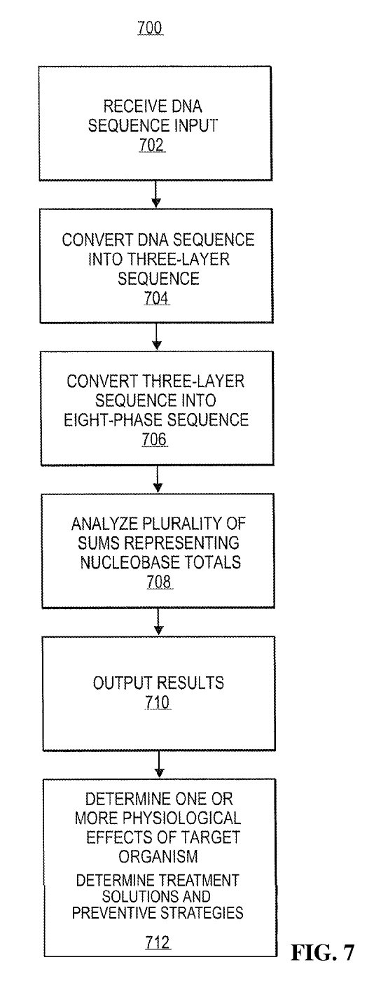

For example, as shown in FIG. 6, a DNA analysis method configured according to the invention receives a DNA sequence input at 602 and converts it into a reassembled sequence at 604. A result based on the reassembled sequence may then be output at 606.

### Foundational Inventive Theories:

Following are theories newly developed within this invention, that serve as the basis for the method and apparatus disclosed. Accuracy of these theories has been demonstrated via the disclosed methods described in the sections below. More than 120 pathogen sequences had been tested and verified, the predicted results matched well with the published information from WHO and CDC.

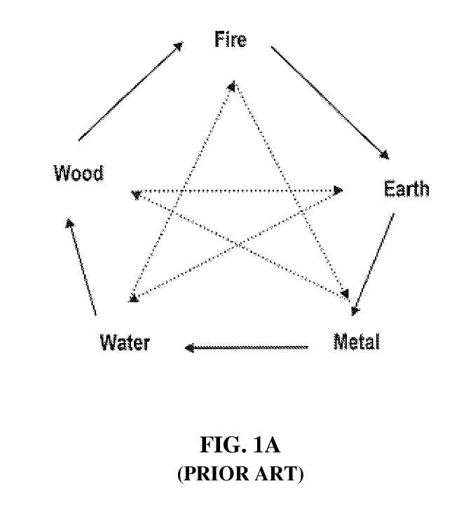

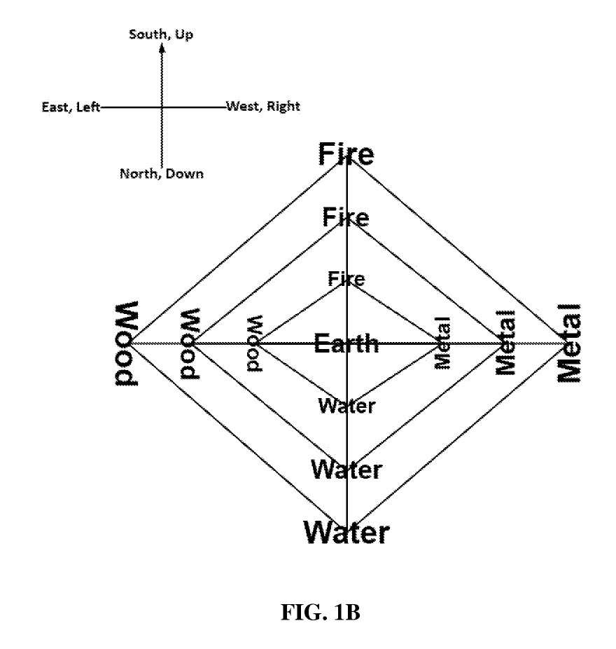

Five Dynamic Energy Channel Theory: The concept of the Five Element ( [symbol] ) was first introduced in a book called Shang Shu—Hong Fan around 1100 B.C. The book clearly stated: “Wu Xing: ONE is called Water; TWO is called Fire; THREE is called Wood; FOUR is called Metal and FIVE is called Earth. Water moisten down; Fire burns up; Wood can be straighten or bent; Metal breaks through; Earth nourish and grows crops. Things that moisten down taste salty; things that burns up taste bitter; things that can be straighten or bent taste sour; things that breaks through taste pungent; things that grows the crops taste sweet.” Years later, the classic text of Traditional Chinese Medicine called Huang Di Nei Jing (or the Yellow Emperor's Classics of Internal Medicine, 770 BC-221 BC) [1] further links colors, orientations, the four seasons and the life cycle of living organisms with these dynamic energies. For example, Water is linked with black, north, winter, coldness and death; Wood is linked with green, east, spring, wind and growth; Fire is linked with red, south, summer, heat and strong; Metal is linked with white, west, autumn and harvest, dryness; and Earth is linked with yellow, the center, late summer, dampness and nourishment. TCM practitioners later developed the Five Element Promotion-Suduction Theory as indicated in FIG. 1A. Solid arrows represent the “production” relationships whereas the dotted arrows represent the “subduction” relationships. [2]

However, instead of thinking in terms of “five elements” or “five things”, I think in terms of “Five Dynamic Energy Channels” since the Chinese word “Xing” or “ [symbol] ” means moving and lineup. That is, the five basic energies from nature each has distinct characteristics, colors and orientations that are aligned to form five dynamic energy channels. Together, they form everything and every energy cycle in nature. A concentric tetrahedral structure may be the most stable form of the system. FIG. 1B illustrates the concept of the Five Dymanic Energy Channel Theory.

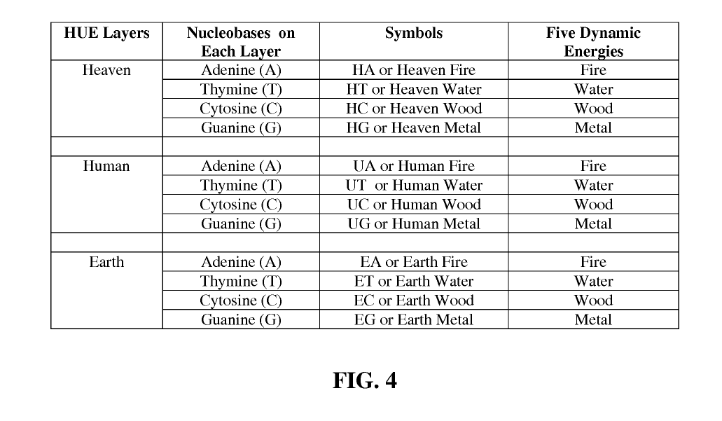

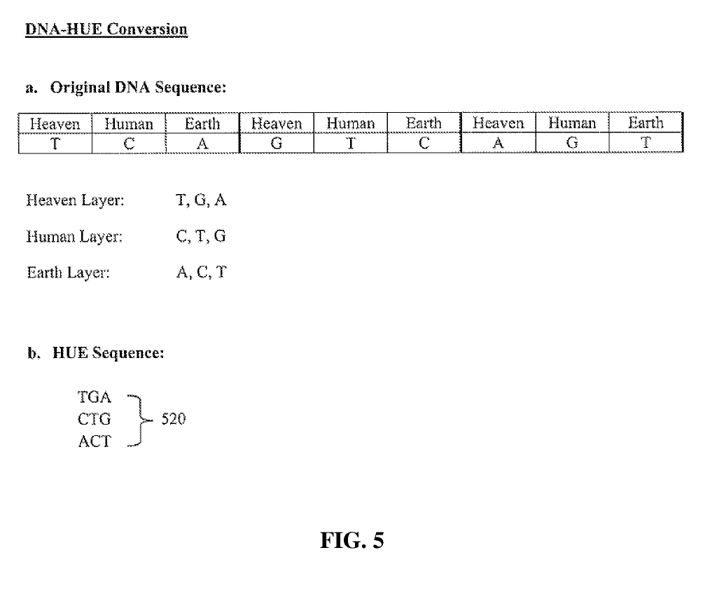

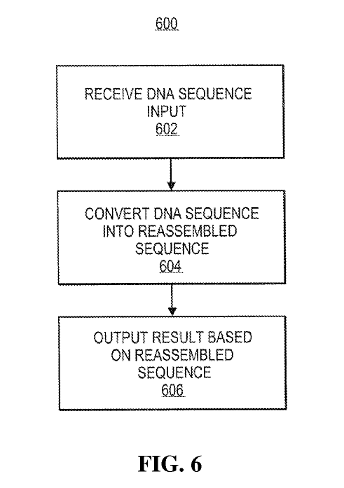

DNA Five Dynamic Energy Theory: DNA also has Five Dynamic Energy qualities. The correspondence between the DNA nucleobases and the Five Dynamic Energy Qualities are listed in the FIG. 4. Adenine (A) corresponds to Fire because it is energy rich, Thymine (T) to Water because it has the lowest energy and absorbs UV light, Guanine (G) to Metal because it provides iridescence, Cytosine (C) to Wood because it assists energy conversion, helps growth, and it pair up with Guanine, the Metal, and the Sugar-Phosphate backbone to Earth because it is the center and supports other elements. As we can see, Fire must pair up with Water (A must pair up with T), Wood must pair up with Metal (C must pair up with G). These base-pairs must match with each other in order to keep the system balanced.

The Three Layer DNA Structure: For many complex organisms, such as human being, all of their tissues and organs are raised from three primary germ layers. Everything evolves together over their lifetime. If DNA is the blueprint of life, then it must contain corresponding layers that are responsible for this process. If DNA is a fractal, as also proven by recent scientific study [3], its basic unit cell must be structured in the same way right from the beginning. I name these three DNA layers Heaven, Human and Earth (or HUE) where Heaven is responsible for the development of the Ectoderm family, that includes all the tissues and organs raised from the Ectoderm; the Human is responsible for the development of the Mesoderm family, that includes all the tissues and organs raised from the Mesoderm; and the Earth is responsible for the development of the Endoderm family, that includes all the tissues and organs raised from the Endoderm.

Four Dimensional DNA Fractal Theory: Fractal is a system where the basic unit of the whole is a reduced copy of that whole. If DNA is a fractal and the blue print of life, the organism it represent must be a fractal as well. Since all living things are four dimensional entities, the fractal must be four dimensional too.

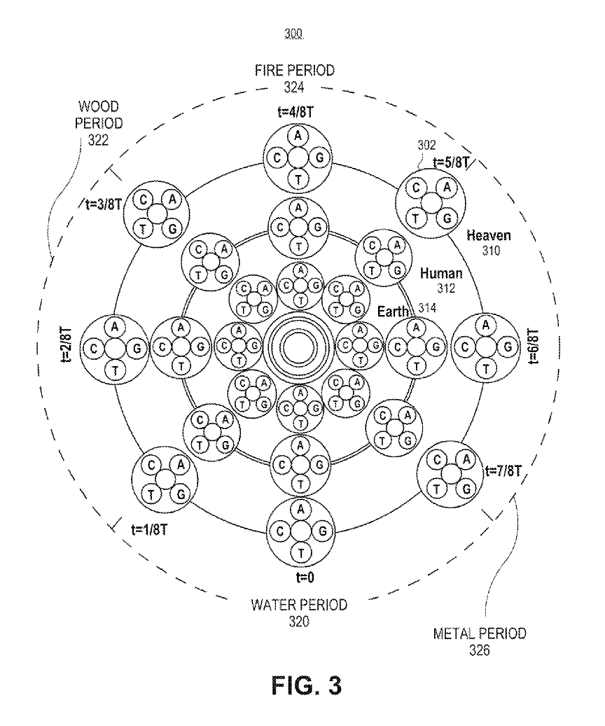

The Four-Period Concept: As a year has four seasons, the life cycle of a natural organism, such as a human, may also be considered to include four periods. The four periods generally entail changes in the internal condition or energy level of that organism. Each period embodies one of the Five Dynamic Energy qualities. For example, the Wood Period is when everything grows, the Fire Period renders the physical body at its strongest state, the Metal Period is when internal energy starts to fall and the body is likely to be dehydrated, and the Water Period is when the body contains least energy during its life cycle. This concept aids practitioners in understanding the internal constitution of the patient in the diagnostic process. For example, a disease causing high fever may be more likely to significantly affect individuals in their Fire Period, rather than those in their Water Period. FIG. 3 illustrates the Four-Period Concept and its relationship with the 8 phases together with the HUE Structure.

HUE Structure: The HUE Structure is a 3×4×8 matrix where 3 represents the three layers: Heaven, Human and Earth; 4 represents the four DNA nucleobases A, T, C and G on each layer of HUE; 8 represents the 8 phases of the lifecycle of the target organism. Since nucleobases have Five Dynamic Energy Qualities as described above, they are two dimensional entities each has unique orientation. This makes the HUE structure a four dimensional spacetime system. The concept of HUE is shown in FIG. 3. Shown as element 302, it includes a two-dimensional plane where the Fire-Water axis is perpendicular to the Wood-Metal axis, and the Earth element stays in the middle. “3” represents the Heaven 310, Human 312 and Earth 314 layers. “8” corresponds to 8 equal phases in a time domain T. The eight time phases may be considered to include the four periods as described above: Water Period 320, Wood Period 322, Fire Period 324, and Metal Period 326.

Theory of Correspondence: In the context of the Fractal, a “correspondency” exists for two things on the same axis. Thus, when a change occurs in one, the other must be affected as well. For example, suppose A, B, and C are three subsystems within a Fractal System called S. The four-dimensional properties of subsystem A (Xa, Ya, Za, and Ta) are correspondent to the properties of subsystem B (Xb, Yb, Zb, and Tb), the properties of subsystem C (Xc, Yc, Zc, and Tc), and the properties of whole system S (Xs, Ys, Zs, and Ts). If there is any disturbance to Xa, then Xb, Xc, and Xs will all be affected at the same time and the whole system will lose balance. To regain the balance, adjustment must be made at these corresponding positions. It should be noted that time is treated the same way as the other three dimensions. That is, all subsystems are synchronized.

Imbalance in DNA cause diseases: Generally speaking, each organism can be considered as an individual energy system and a subsystem of its environment. A healthy organism is a balanced energy system by itself and with its environment. Since the Five Dynamic Energies are always aligned, any imbalance within the organism will not just cause instability to itself, but will also cause disturbance to its environment. Similarly, when a foreign organism enters a human body (a new environment), their A, T, C and G in every HUE layer and each phase must be aligned with the host's DNA. That means, the pathogen's HA@ ⅛T must join the host's HA@ ⅛T and the pathogen's UT@ ⅞ must join the host's UT@ ⅞, and so on. Any imbalance of this union of DNA, having too much or too little of Adenine, per se, will cause the original balance of the host to be broken. When the imbalance reaches a substantial level, the patient's physical characteristics, such as body temperature, blood pressure, or even appearance may change.

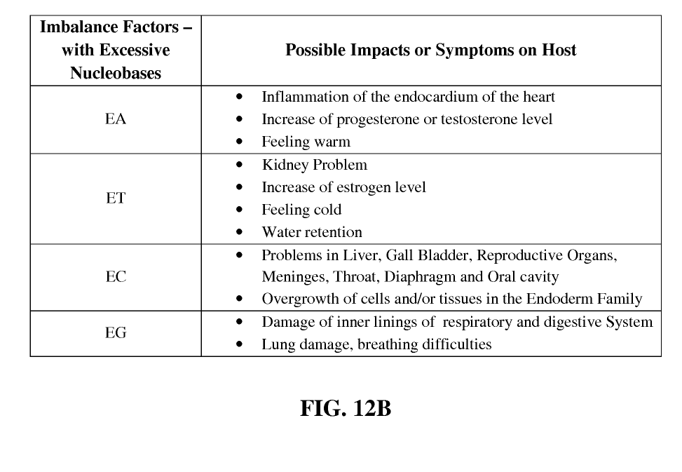

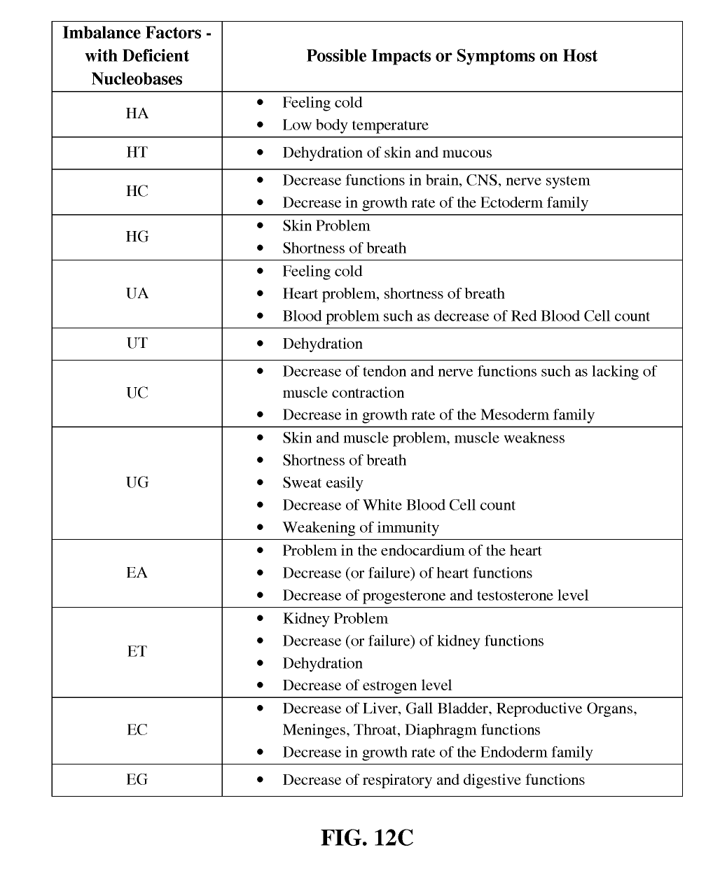

Imbalance Factors: When the nucleobases on the HUE Structure become either relatively too much (excessive) or relatively too little (deficient), they become the Imbalance Factors that break the balance of the system. FIG. 12A, FIG. 12B and FIG. 12C illustrate examples of the Imbalance Factors and their impacts on the host.

Measuring the Imbalance: By calculating the sum and ratio of the nucleobases on the HUE Chart, we will be able to determine the Imbalance Factors. For example, in a perfectly balanced condition, HA:HT=1. However, when HA:HT ratio is greater than 1, we say HA is in excessive condition whereas HT is in deficient condition. The bigger the ratio, the bigger the impact these Imbalance Factors might create on the host.

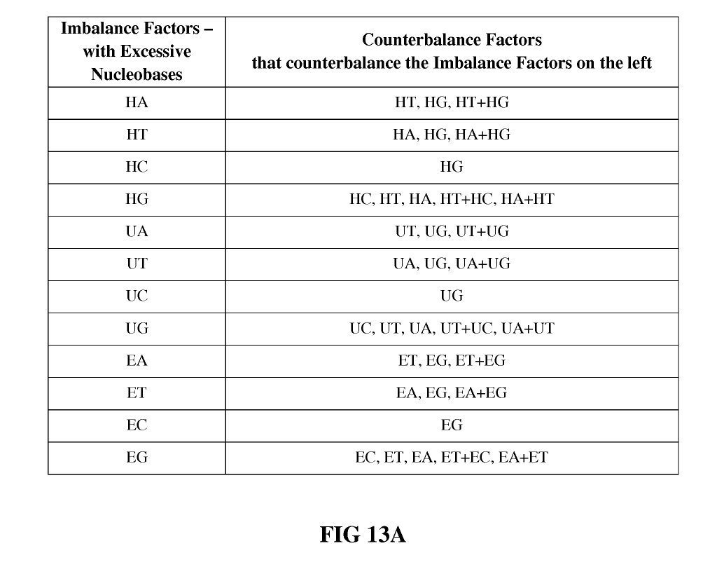

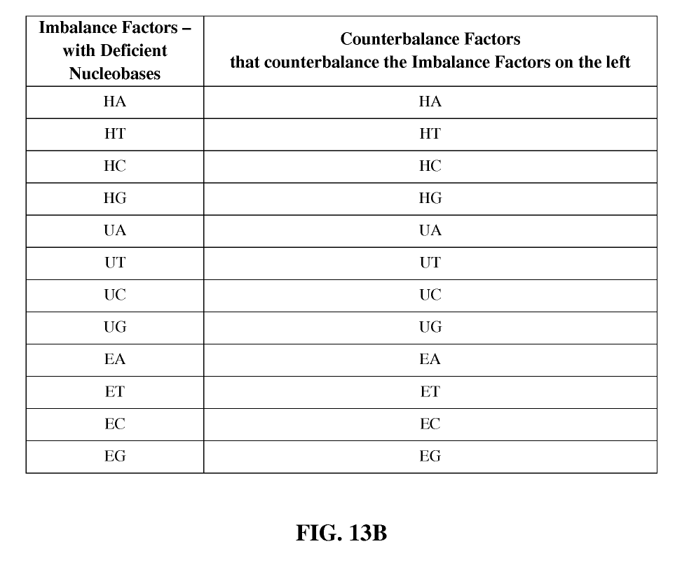

Counterbalance Factors: Counterbalance Factors counterbalance the Imbalance Factors. Counterbalance Factors may exist in anything, such as herbs, food, synthezised or natural biomaterials. Examples of Counterbalance Factors are listed in FIG. 13A and FIG. 13B.

Reverse Imbalance Method: The Reverse Imbalance Method applies one or more of the following 3 methods with the goal to bring the host back to a balance state: (1) use Counterbalance Factors to offset the imbalance caused by the target organism, (2) remove certain quantity of the excessive nucleobases caused by the target organism, (3) increase the quantity of the nucleobases which is in deficient condition caused by the target organism.

Prevention Method: The Prevention Method aims to avoid further imbalance. That means, if the imbalance is caused by excessive quantity of certain types of nucleobases, to avoid further imbalance, one should avoid taking more of the same kind of the nucleobases. On the other hand, if the imbalance is caused by deficiency of certain types of nucleobases, one should increase the input of that nucleobases.

The Target Organism: The target organism can be any organism or DNA sequence, such as virus, bacteria, plasmids of the bacteria, proteins or mutated genes, that may create physiological impacts within the host.

The Input DNA Sequence: The input DNA sequence is the genome sequence of the Target Organism which may include a digital nucleobase representation with a known format, such as GENBANK or FASTA. The starting point of the sequence is predetermined.

### Applications:

Treating and Preventing Diseases. This invention may allow us to understand the exact cause of a disease and predict its development. It helps researchers and medical providers to quickly understand how a foreign DNA sequence such as infectious diseases may impact human health. Since it directly links pathogens' genomic data with symptoms and sites of infections, it gives scientists and doctors early indications of “where to look” and therefore, dramatically reduces the time and cost of investigation

Selecting the right food for individuals. This invention may allow the government and consumers to monitor the nature and safety of foods and drugs that we may take in our daily lives. This invention may thus allow an individual to serve as his/her own nutritionist, maintaining health balance by simply choosing the suitable food from nature. This naturally renders a low-cost, effective health care system.

Effective agricultural planning and food saving. The invention may allow farmers to predict exactly how a plant will grow and what conditions it requires. Farmers can thus build an optimal planting environment and choose the best harvest time. Knowing how energy distributes through a plant (i.e., including leaves, fruits, stems and roots), allows us to make use of the food effectively.

### Method:

The method according to an embodiment of the invention may: (1) map the DNA of a target organism onto a HUE structure, and (2) determine how the target organism may affect its host, (3) suggest treatment strategy, (4) suggest preventive strategy.

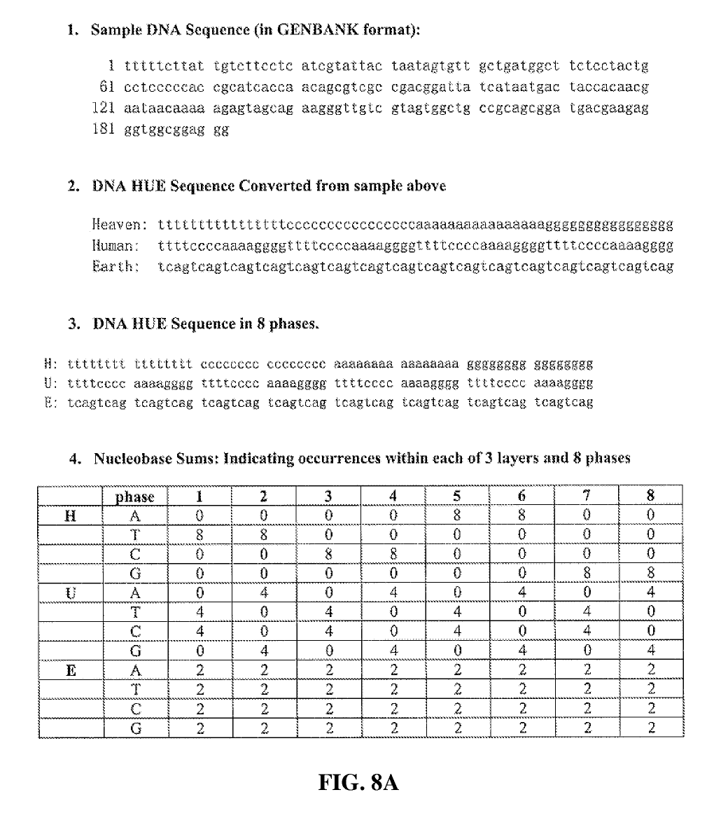

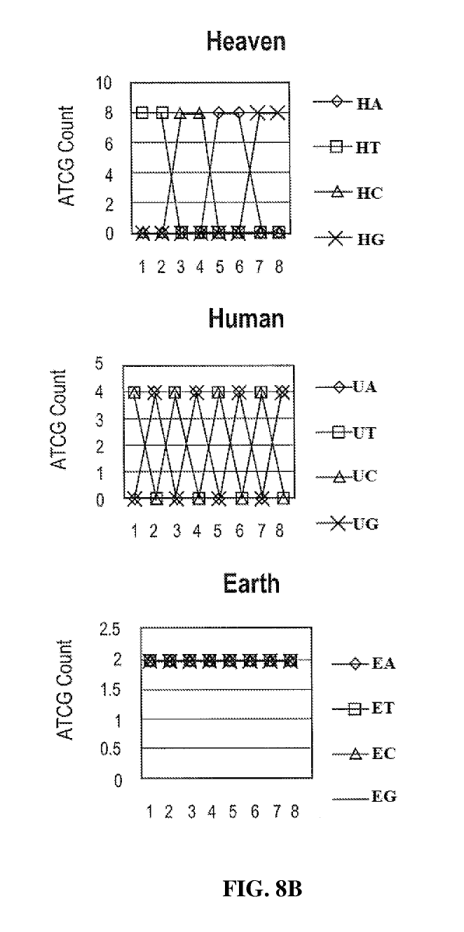

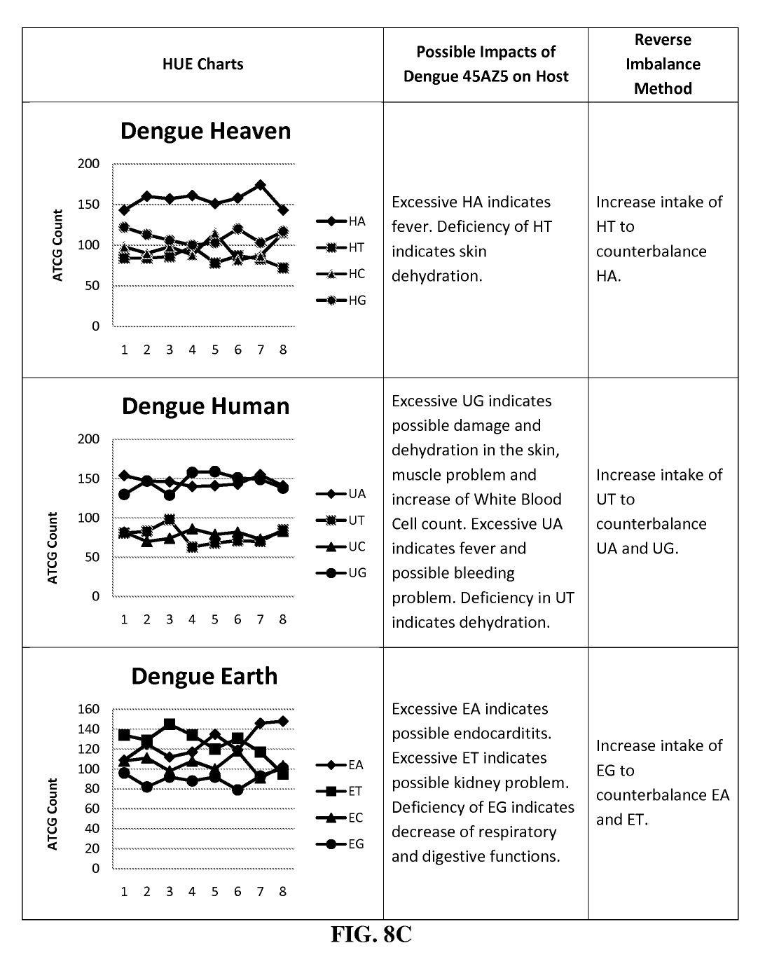

Flowchart 700 of FIG. 7 illustrates a method, to be performed by, for example, a DNA analysis system, configured according to an embodiment of the invention. At 702, a DNA sequence input is received at, for example, an input module. This input may include a digital sequence with nucleobase representations, such as a “ready-made” DNA sequence in GENBANK or FASTA format. Alternatively, actual DNA may be obtained by, for example, extraction from the target organism, after which a DNA sequence is produced by a sequencer. The starting point of the DNA sequence is predetermined before entering the DNA analysis system. A sample DNA sequence in GENBANK format is shown at FIG. 8A-1.

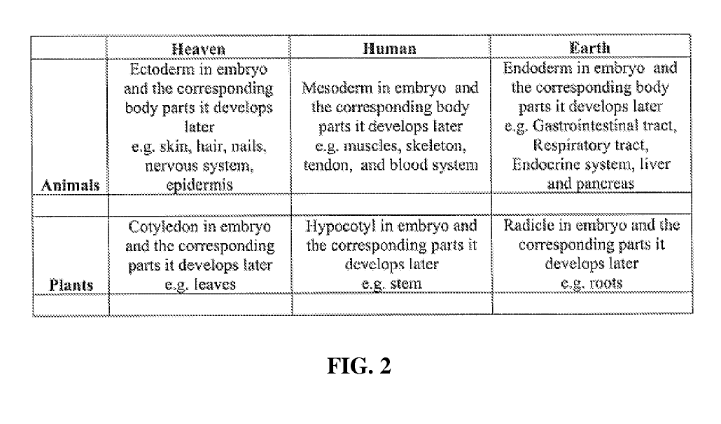

At 704 and 706, the DNA sequence input comprising a plurality of triplets of nucleobase representation is converted into a reassembled sequence by, for example, a processor. At 704, the DNA sequence may be first converted into a three-layer sequence such as the HUE sequence shown in FIG. 8A-2. In a HUE sequence, a first layer comprising a first element of each triplet in the DNA sequence input, a second layer comprising a second element of each triplet in the DNA sequence input, and a third layer comprising a third element of each triplet in the DNA sequence input.

At 706, the three-layer HUE sequence may be divided into eight phases. Each phase occupies ⅛T of a complete cycle where T is the cycle time. Each of the 8 phases may later be subdivided into smaller units for more detailed analysis. An example of an eight-phase sequence is shown at FIG. 8A-3. The remainder of the division, if any, will be ignored.

At 708, a plurality of sums may be analyzed, wherein each one of the plurality of sums indicates the total occurrence of, respectively, each one of four nucleobase representations within each of the three layers and eight phases, to produce an analysis result. For example, as shown at FIG. 8A-4, respective sums of each purine Adenine (Fire), Thymine (Water), Cytosine (Wood) and Guanine (Metal) for every layer and phase is determined. In the case that multiple DNA sequences are entered, a comparison may be performed. In addition, a ratio in accordance with at least two of the plurality of sums may also be analyzed. The result will be used to determine the Imbalance Factors that may cause the imbalance of the host.

At 710, one or more of the above-described results may be output by, for example, an output module. The results may be displayed in, for example, a visual-friendly form, such as a graph, chart, table, figure, or outline. The output module may display various results, such as a reassembled sequence including either the HUE sequence of FIG. 8A-2 or the 8-phase sequence of FIG. 8A-3, or both. A chart of the plurality of nucleobase sums, such as that of FIG. 8A-4, may be shown as well. A more graphically readable representation of the sums of FIG. 8A-4 is shown in FIG. 8B. Clearly, the DNA sample depicted in FIG. 8A and FIG. 8B are not a realistic representation of results for a true organism, but rather, serves as an understandable example of the described analysis method. However, the samples depicted in FIG. 8C represent the HUE Chart of a real pathogen strain, Dengue 45AZ5.

Information that may help the user to determine the analysis results, treatment solutions and preventive strategies, such as FIG. 12A, FIG. 12B, FIG. 12C, FIG. 13A and FIG. 13B may be output at 710 as well. This information may also be provided to the user via any media, such as the internet, The information may be presented in various formats, such as but not limited to texts, tables, charts, graphs or photos.

Once the results are output at 710, a practitioner may interpret the results, determine treatment solutions and preventive strategies based on previously known medical and TCM analytical methods, as well as the newly developed theories disclosed herein. A practitioner may also determine the results based on a set of predefine criteria, such as the information listed in FIG. 12A, FIG. 12B and FIG. 12C.

At 712, the processor may further determine one or more physiological effects of the target organism, embodying the input DNA sequence, on a host organism, to produce a determination result. For example, as we can see from the HUE Chart of Dengue 45AZ5 shown at FIG. 8C, the ratio between HA and the other three nucleobases is much greater than 1, that means excessive HA dominate the Heaven layer. From FIG. 12A, FIG. 12B and FIG. 12C, we know that excessive HA will cause Fever, thus we can predict Dengue 45AZ5 may cause fever in the host. Similarly, excessive UA and UG dominates the Human layer while UT is in deficient condition, again based on FIG. 12A, FIG. 12B and FIG. 12C, we can predict that fever, bleeding, damage of skin and dehydration are also possible symptoms of Dengue 45AZ5. If the ratio between the nucleobases change over the 8 phases, the symptoms will also change accordingly. To get the final result, we need to combine our readings from all HUE layers at all phases.

At 712, the processor may also determine treatment solutions based on the Reverse Imbalance Method and preventive strategies based on the Prevention Method disclosed herein. For example, as shown at FIG. 8C, a Dengue 45AZ5 patient may start to show high fever, bleeding and dehydration. The DNA analysis system may suggest treatment solutions based on the Reverse Imbalance Method, such as use HT to counterbalance excessive HA, use UT to counterbalance excessive UA, and use UC or UT to counterbalance excessive UG. Based on the Prevention Method, the system may also suggest the patient to increase the intake of ingredients with high HT and UT content but decrease intake of ingredients with HA, UA and UG to avoid worsening the symptoms.

### Apparatus:

In an embodiment of the invention as shown in FIG. 9, a DNA analysis system for performing a method as described above may comprise an input module 902 to receive a DNA sequence input, a processor 904 to convert the DNA sequence into a reassembled sequence; and an output module 906 to output a result based on the reassembled sequence.

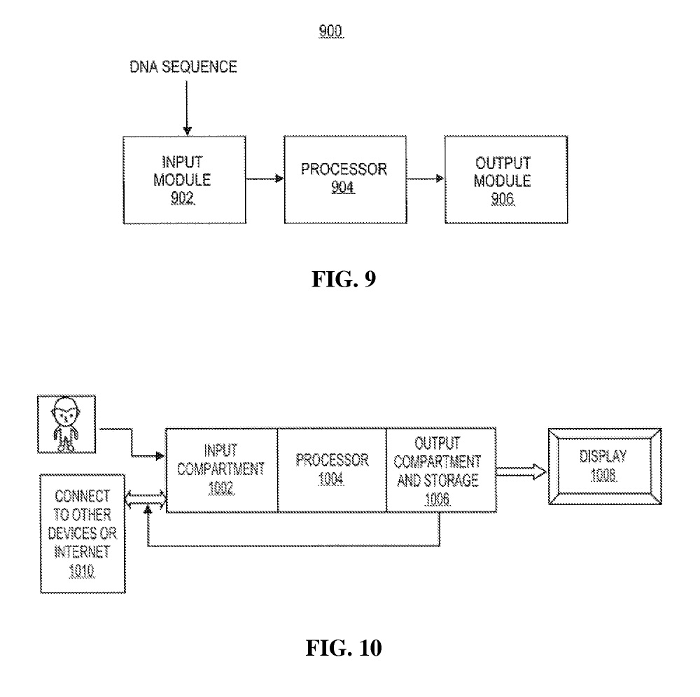

Another embodiment of a DNA analysis system is shown in FIG. 10. The input compartment 1002 may receive a DNA sequence from any source, including from the a DNA sequencer which directly extract and sequence the DNA from the target organism or from an outside storage such as via an internet connection at 1010. The system includes processor 1004 to perform the processes described above. The output compartment 1006 may include a storage unit to save results, and may output results to display 1008. The output compartment may also allow the user to output results to another device via the external connection at 1010.

In an embodiment of the invention, the system may allow the user to enter multiple DNA sequences for comparison. The system may include a software running from a host computer or a module that is embedded inside a multi-functional device.

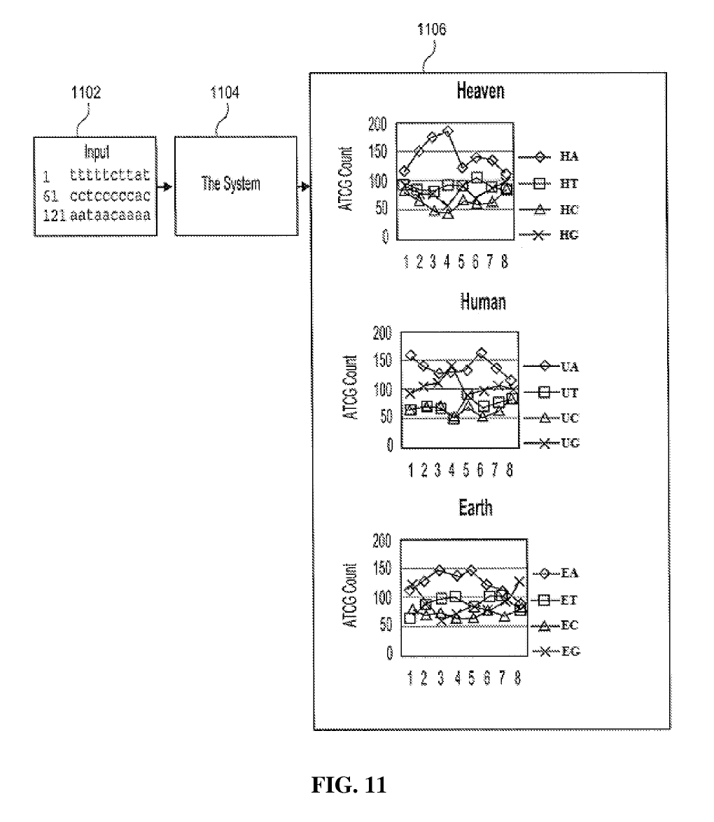

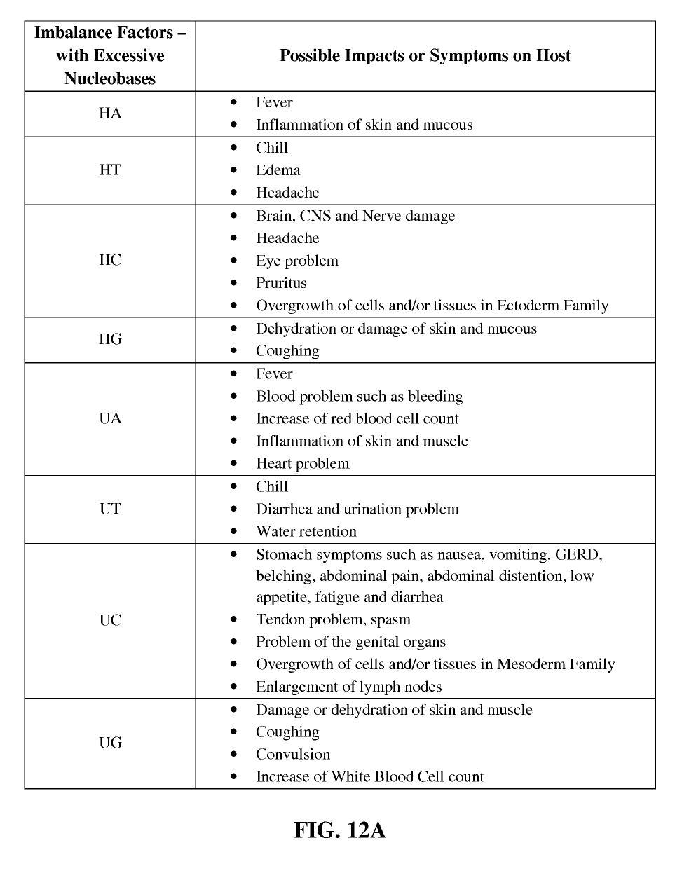

FIG. 11 illustrates an input DNA sequence 1102 entering the DNA analysis system 1104, which displays HUE chart results 1106.

The invention may also involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The methods and systems disclosed herein include a novel approach for understanding, treating, and preventing infectious diseases, as well as the effects of various organisms on various hosts in general. However, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims and their equivalents.

### REFERENCES

1. Huang Di Nei Jing, The Four TCM Classics in Modern Chinese, Du Zhou Liu, Tian Jin Science and Technology Publishing Company, 1994.
2. Chinese Medicine Fundamentals, 5^{th} Edition, Dun Xu Wu, et al, Shanghai Science and Technology Publishing Company, 1995
3. DNA is a fractal antenna in electromagnetic fields, Blank M, Goodman R, Int J Radiat Biol. 2011 April; 87(4):409-15. Epub 2011 Feb. 28.

What is claimed is:

1. A DNA analysis method, comprising:
accessing a DNA sequence input, the DNA sequence input comprising a plurality of triplets of nucleobase representation;
converting the DNA sequence input into a reassembled sequence, wherein the reassembled sequence includes three layers: a first layer comprising a first element of each triplet in the DNA sequence input, a second layer comprising a second element of each triplet in the DNA sequence input, and a third layer comprising a third element of each triplet in the DNA sequence input; and
outputting an output result based on the reassembled sequence.

2. The DNA analysis method of claim 1, wherein the DNA sequence input is a genome sequence of a Target Organism.

3. The DNA analysis method of claim 1, further comprising: dividing with the processor the reassembled sequence into eight phases, each of the eight phases representing ⅛ of a complete time cycle.

4. The DNA analysis method of claim 3, further comprising: dividing the reassembled sequence into further subdivided phases within each of the eight phases.

5. The DNA analysis method of claim 4, further comprising: analyzing a plurality of sums, wherein each one of the plurality of sums indicates the total occurrence of, respectively, each one of four nucleobase representations within each of the three layers and eight phases, to produce an analysis result.

6. The DNA analysis method of claim 5, further comprising: analyzing a ratio in accordance with at least two of the plurality of sums, and determining the analysis result based on their ratio.

7. The DNA analysis method of claim 1, further comprising determining a physiological effect of a target organism on a host organism, the target organism embodying the input DNA sequence, to produce a determination result.

8. The DNA analysis method of claim 7, wherein the determination result is based on one of a Five Dynamic Energy Channel Theory, a DNA Five Dynamic Energy Theory, a Four Dimensional DNA Fractal Theory, a Theory of Correspondency, a HUE Structure, and a Four-Period Concept.

9. The DNA analysis method of claim 7, wherein the host organism is a human, animal, or plant.

10. The DNA analysis method of claim 7, wherein the determination result is based on Imbalance Factors.

11. The DNA analysis method of claim 1, further comprising: producing a treatment strategy based on a Reverse Imbalance Method.

12. The DNA analysis method of claim 1, further comprising: producing a prevention strategy based on a Prevention Method.

13. The DNA analysis method of claim 1, wherein the result output includes one of a graph, chart, table, figure, photo, and outline.

14. A DNA analysis system comprising:
an input module for accessing a DNA sequence input, the DNA sequence input comprising a plurality of triplets of nucleobase representation;
a processor for converting the DNA sequence input into a reassembled sequence, wherein the reassembled sequence includes three layers: a first layer comprising a first element of each triplet in the DNA sequence input, a second layer comprising a second element of each triplet in the DNA sequence input, and a third layer comprising a third element of each triplet in the DNA sequence input; and
an output module for outputting an output result based on the reassembled sequence.

15. The DNA analysis system of claim 14, wherein the DNA sequence input is a genome sequence of a Target Organism.

16. A tangible non-transitory computer-readable storage medium that stores computer instructions which, when executed by a computer, cause the computer to perform operations comprising the DNA analysis method of claim 1.
